(19) United States
(12) Patent Application Publication
(10) Pub. No.: US 2006/0190418 A1
(43) Pub. Date: Aug. 24, 2006

(54) System and method of postal-charge assessment

(76) Inventors: Michael Huberty, Apple Valley, MN (US); Jeffrey S. Poulin, Endicott, NY (US)

Correspondence Address: LOUIS J FRANCO;LAW OFFICE OF LOUIS J FRANCO, 250 ARBOR, LUNENBURG, MA, 01462, US

(21) Appl. No.: 11/065,185

(22) Filed: Feb. 24, 2005

(51) Int. Cl. G06F 17/00

(52) U.S. Cl. 705/402

(57) ABSTRACT

A system and method of postal-charge assessment facilitates the production of mail pieces exhibiting a collective postage-fee payment code issued by a postage vendor and authorized to be applied to a plurality of mail pieces in response to a postal-customer request. There is associated with the process no inherent limit on the number of mail pieces exhibiting the collective postage-fee payment code that the requesting postal customer can cause to have produced; the postal customer is, instead, assessed a postal charged only for those mail pieces exhibiting the postage-fee payment code that are detected in the postal system. The requesting postal customer has the option of associating limitations with the collective postage-fee payment code such as (i) restrictions on authorized delivery addresses, (ii) a postage expiration date and (iii) a limit of the quantity of mail pieces exhibiting the postage-fee payment code that can be introduced into the postal system.

### BACKGROUND

A traditional process for the payment of postage for the movement of a mail piece through a postal system and delivery to an addressee includes the purchase of postage indicia (e.g., a stamp, meter mark or other postage-paid indicia), applying the indicia to the mail piece, and introducing the mail piece into the postal system for movement through the mail stream. Such traditional processes involve the pre-payment of postage; that is, the payment of postage before the mail piece to which the postage-paid indicia evidencing payment and applied to the mail piece is introduced into the mail stream. “Response Services” represent alternatives to pre-paid postage options and allow postal customers such as large businesses to provide their customers with pre-printed mail pieces for which postage is not billed to the response services postal customer until such mail pieces are detected in the mail stream. “Response Services” include a variety of mail products designated by such names as “Business Reply” and “Freepost.” Response Services mail pieces are typically identified by a “license plate” on the front face of the mail piece that contains, for example, a business reply permit number and other, optional information such as the city of issuance. The postal service assesses a license fee for business reply mail services and collects the actual postage for each reply services item that is detected in the mail stream. Among the benefits of response services to large businesses are (i) the ability to provide postage-paid mail pieces (e.g., envelopes or post cards) to their customers and (ii) having to pay postage only for those mail pieces detected in the postal system. The business reply system is essentially a mechanism for “reversing the charges” from the sender to the recipient, and only for those items actually mailed by, for example, potential prospective customers. Among the disadvantages of current response services systems is that revenue collection is an intensive process heavily reliant upon manual labor undertaken by postal service personnel at or near the point of delivery. Experience has revealed the relative procedures to be highly prone to error and otherwise contributory to lost revenue. Furthermore, in its current state of existence, the process is not easily changed due to the limitations inherent in automated mail-processing equipment to accurately interpret a high percentage of human-readable license numbers and other optional information that is necessary to reliably assess charges to the postal customer.

Recent developments in technology related to the procedures by which postal customers do business with the postal service have given birth to systems by which postal customers can purchase postage over a computer network (e.g., the internet) and download from a vendor site information-based postal indicia that can be printed onto mail pieces by the postal customer's own computer printer. One such system, and the software and apparatus associated therewith, is marketed to the public under various PC-Postage® trademarks and service marks registered and, in some cases, applied-for by the United States Postal Service. As advertised, the PC-Postage® system allows postal customers to purchase and print U.S. postage using a computer, a printer, and an internet connection. The postal customer can print exact postage on envelopes, sheets of stamps, and shipping labels for packages. Based on data entries provided by the postal customer, postage is automatically calculated and deducted from the balance of a pre-established postal-customer account. In order to facilitate accurate automated sortation within the postal system of the mail piece to which the printed indicia is applied, a machine-readable barcode is added to the stamp, envelope or mailing label. The barcode is generated based on the delivery address information entered by the user and contains, in code, information corresponding to the human-readable destination address information entered by the postal customer. The United States Postal Service regulates the activities of all companies authorized to distribute postage indicia via the internet. Three companies currently authorized to distribute postage under the PC-Postage® trademarks and service marks are Stamps.com, Endicia.com and ClickStamp.

Purveyors of, for example, the PC-Postage® product and service line still, in a general sense, adhere to the traditional postage payment process (e.g., a “stamp” or “meter mark” paradigm) according to which the postal customer pre-pays for the postage, applies the information-based indicia to a mail piece and deposits the mail piece into the mail stream. The postal customer is charged for the postage at the time the indicia are printed by, for example, having the postage amount debited from a pre-paid account. Current standard practice includes embedding a unique identifier in the machine-readable indicia to be applied to each mail piece. In effect, the unique identifier is a serial number that provides financial accountability for the indicia and traceability of the mail piece. Once a unique identifier is communicated to a postal customer who purchases postage on-line, that unique identifier is retired (i.e., rendered inactive) to prevent its future use.

Accordingly, there exists a need for a system that permits the user of a print-on-demand postage system (e.g., PC-Postage) to adhere to a plurality of mail pieces information-based indicia that can be detected by automated postal machinery and that facilitates the assessment of charges to the postal customer, not at the time of printing of the indicia, but after a mail piece exhibiting the indicia has been entered into the mail stream. A need also exists for a system that allows response services postal customers to conveniently mass produce business reply mail pieces to which are adhered information-based, postage-fee accounting indicia which, when detected in the mail steam, facilitate the assessment of appropriate postal fees to the postal customer, but which also (i) limits the exposure of that postal customer to the fraudulent duplication of the postage-fee accounting indicia and (ii) limits the postal service's exposure to the handling of response services mail pieces for which it cannot collect postage.

### SUMMARY

Various implementations involve participation by a response services (e.g., business reply) postal customer, a postage vendor, a postal service that receives, handles and delivers mail pieces to addresses, and mail-piece recipients, the mail-piece recipients being customers or prospective customers of the response service postal customer. In various aspects, the postage vendor and the postal service are one and the same entity, but, as is the case currently in the United States in connection with the sale of pre-paid postage indicia, for example, the postage vendor may be an entity authorized and regulated by the participating postal service. For purposes of clarity in the description, however, the postal service and postage vendor are separately designated.

An illustrative process is initiated with the communication of a postal-customer request for postage-fee accounting indicia by or on behalf of a postal customer to a postage vendor. The typical postal customer involved in the process is a business entity seeking to send a multitude of similar business reply mail pieces (e.g., cards or envelopes) to its customers or to persons or entities that the postal customer believes represent potential business prospects. For instance, a magazine company that publishes a magazine dedicated to Colonial American History may reasonably regard an existing subscriber to a magazine dedicated to the American Revolution as a potential subscriber to its magazine and, therefore, may have in place a business strategy that includes mailing a limited number of complimentary copies of its magazine to the prospect and including therein a “business reply” card for the prospect to return to the publisher as a means of initiating a subscription. It is advantageous to such a company, in keeping with traditional business reply mail practices, to retain the capacity to produce, or to have produced by a contracting entity (e.g., a printer), a large quantity of identical business reply mail pieces.

The postal-customer request is electronically communicated from a requesting station which, in a typical implementation, is a general use computer or computer terminal, but which may also be a dedicated computer or other dedicated postage-requesting apparatus. Moreover, the requesting station may, in alternative implementations, be situated at the place of business of the postal customer on whose behalf the request is initiated, at the place of business of an entity contracting with the postal customer for the production of mail pieces or at a postage kiosk, by way of non-limiting example. For purposes of simplicity in the explanation, and as an indication of the breadth of implementations conceptually encompassed by the appended claims, a request from the postal customer includes a direct request from the postal customer's place of business by, for example, an employee of the postal customer or a request otherwise communicated on behalf of the postal customer from any location by any person or entity authorized by the postal customer.

In response to the postal-customer request to the postage vendor, a “group” or “collective” postal-fee payment code is associated with data indicative of the identity of the requesting postal customer and other, optional information, and a computer memory record of a postal-order-data set including data indicative of the postal-fee payment code and of the postal customer's identity is stored in a postal-customer account database in which is stored data uniquely relating each requesting postal customer with data indicative of a set of postal-customer requests registered in association with that postal customer. Illustrative data indicative of the identity of the postal customer includes at least one of, by way of non-limiting example, an entity name, an entity address, a delivery address, a pre-established postal account identifier (e.g., account number), financial-institution routing and account numbers and a credit card number. The collective postal-fee payment code is communicated to the requesting postal customer and is, in various aspects, authorized to be associated with, and exhibited on, a predetermined quantity of physical mail pieces to be introduced into the postal stream. In a typical implementation, the postal-fee payment code is embedded in a graphic (e.g., a one dimensional bar code or two-dimensional data matrix), which graphic may also include coded portions corresponding to and indicative of other, optional information as indicated, for example, above.

A predetermined authorized quantity of mail pieces is one example of additional information that may be explicitly stated as part of the postal-customer request or implicitly authorized by a stated dollar amount up to which postage fees may be assessed to the postal customer in connection with that request. For instance, the request may specify 50,000 business reply cards all of which conform to a uniform set of size, destination, class and weight parameters or the request may be limited instead by a dollar amount (e.g., $10,000). In the latter case, response services mail pieces exhibiting the collective code would be accepted into the mail stream and delivered up to the point that the cumulative postage of all such mail pieces exceeds the $10,000 cap, for instance. In alternative implementations, the collective code may be associated with an “open” order with no implicit or explicit limit on the quantity of physical mail pieces that can exhibit the postal-fee payment code and be detected in the mail stream. However, it will be appreciated that each of (i) a mail-piece quantity limit and (ii) a dollar (or foreign-currency equivalent) limit on the postage request limits the postal customer's exposure to financial loss attributable to the fraudulent duplication and application by unauthorized persons or entities to mail pieces of the postal-fee payment code. Another measure of security against fraudulent use of a postal-fee payment code is introduced by associating with the postal-fee payment code, for example, a valid-destination address set which set, in some embodiments, includes a single valid destination address and, in other embodiments, includes plural valid destination addresses. Restricting the set of destination addresses to which mail pieces exhibiting the postal-fee payment code can be delivered prevents losses due to fraudulent duplication of the accounting indicia for the mailing of mail pieces to unauthorized addresses. One method of implementing address-based fraud protection is implemented by programming automated mail sortation machinery to mark and/or segregate and treat as potentially fraudulent the exhibition on a mail piece of a valid postal-fee payment code and a nonconforming delivery address; that is, a delivery address that does not correspond to an authorized delivery address associated with the post-fee payment code. Optionally, mail pieces authorized to exhibit the postage-fee accounting indicia include a human readable notice indicating that authorized delivery is restricted to the address as it is optionally displayed in human-readable format on the mail piece. Such a notice would serve as a deterrent to would-be counterfeiters of the accounting indicia because the notice would advise that delivery is restricted to the very entity that the would-be counterfeiters may otherwise attempt to defraud.

From the perspective of the business reply postal customer, it is, in various scenarios, also desirable to have associated with each business reply mail piece a time limit (e.g., a “cut-off” date) by which that mail piece must be introduced into the postal system if the postal customer is to have assessed to it a fee for delivery. Under certain circumstances, such a time limit also protects the postal service against lost revenue for the handling of mail pieces for which it can no longer collect postage. For instance, if a response services postal customer associates with a special, time-sensitive promotion a set of business reply mail cards by which customers or prospects can communicate an interest in the promotion to the response services postal customer, the postal customer loses revenue, under current business reply mail systems, for each business reply mail card delivered to it after the expiration of the promotion. Accordingly, various implementations facilitate the association with the postal-customer request a postage expiration date. Data indicative of the postage expiration date is at least one of (i) embedded in the postage-fee payment indicia exhibited on an authorized mail piece and (ii) associated with the computer memory record of data associated with the postal-customer request for subsequent consultation by automated mail sortation apparatus within the postal system. In various aspects, the automated mail sortation apparatus are programmed to route for non-delivery (i.e., dump out of the mail stream) a mail piece exhibiting expired postage-fee accounting indicia. In addition to permitting a response services postal customer to set a postage expiration date as part of the postal-customer request, the postal service may optionally impose an absolute postage expiration date on certain types of mail generally to guard against the inability to collect fees for handling mail pieces for postal customers that may no longer exist at the time of deposit into the mail stream of a response services mail piece. In those instances in which a response services postal customer associates with the postal-customer request a postage expiration date, the postal service may still encounter numerous deposits of response services mail pieces that the postal service must at least “minimally handle” even though there exists a standing condition not to deliver such mail pieces. Two ways in which a postal service can prevent, or at least mitigate against, losses associated with the “minimal handling” of large numbers of such mail pieces include (i) requiring that each such mail piece conspicuously exhibit the postage expiration date in human-readable format and (ii) assessing a handling fee to the postal customer whose identity is associated with such mail pieces. The aforementioned loss prevention mechanisms may exist in alternative implementations or as dual measures in the same implementation, although the mere existence of a minimal handling fee is probably sufficient motivation to compel response service postal customers to voluntarily exhibit postage expiration dates. On the other hand, reason suggests that the conspicuous exhibition of a postage expiration date would serve to dissuade recipients of response service mail pieces from depositing them into the mail stream subsequent to the indicated expiration date. The inventors note that a postage expiration date may be alternatively specified (i) explicitly in terms of an actual date (e.g., Oct. 15, 2005) or (ii) implicitly by the specification of a time limit for which the postage is valid (e.g., 30 days). The latter expression is still regarded for purposes of the description and the appended claims as specifying a postage expiration date because the expiration date in the latter case is readily calculable based on the date of the postal-customer request. Accordingly, the terminology “postage expiration date” is to be interpreted so as to include a specified “time limit.”

Once a data set indicative of the postage-fee accounting indicia associated with a postal-customer request is communicated (i.e., rendered accessible) to the requesting postal customer, the requesting postal customer causes to have iteratively applied to a plurality of response services mail pieces tangible renditions of the postage-fee accounting indicia. For example, a rendition of the indicia may be directly applied by indicia-printing apparatus (e.g., a laser or inkjet printer) to envelopes or cards each of which will serve as, or constitute a part of, a response services mail piece. Alternatively, the indicia may be applied to a plurality of selectively adhesive labels (e.g., “stickers”) which are then applied to a response services card or envelope. In order to obviate the tedium of excessive exactitude, it is to be understood that, although what is actually being rendered accessible to a requesting postal customer is a data set that the postal customer can then repetitively reduce to a graphic on tangible media (e.g., paper), this process is regarded as within the scope of “communicating” or “rendering accessible” to a postal customer a postage-fee payment indicia. As previously indicated, identical indicia are applied to all the response services mail pieces associated with a particular postal-customer request. Moreover, as previously indicated, the postage-charge assessment is not related to the number of items printed but, rather, the number of response service mail pieces that are actually introduced into the mail stream subsequent to printing.

The postage vendor maintains a postage-request data set in computer memory and that data set is rendered accessible to the relevant postal service so that as mail pieces exhibiting the postage-fee accounting indicia appear in the mail stream, their association with the postal customer corresponding to the postage-request data set can be detected. Access to the postage-request data set is provided, in alternative versions, (i) by dedicated communications link and (ii) via a computer network in real time as required or by the communication of a copy of the data set to the postal service for use when needed, by way of non-limiting example. Again, the postage vendor and the postal service may, in some implementations, be the same entity; however, whether the vendor and postal service are distinct entities or the same entity, communicative access to the postage-request data set by the postal service is required in various aspects for tracking and accounting purposes.

A response services mail piece exhibiting the postage-fee accounting indicia is received into the postal system from, for example, a depositing customer or prospect of the response service postal customer. In a manner consistent with automated processes already in place for other purposes (e.g., address interpretation), and well-known to those of ordinary skill in the relevant arts, information exhibited on at least one surface of the mail piece is conveyed to automated interpretation apparatus through mail-piece data acquisition apparatus. The data acquisition apparatus may include, for example, one or more cameras or optical character recognition (OCR) scanners. Although data may be acquired from a mail piece by alternative methods, the act of mail-piece data acquisition is principally expressed throughout the specification and claims in terms of “image capturing,” “image acquisition,” or “extraction.” Therefore, it is intended that “image capturing,” “image acquisition” and “extraction,” and semantic variations thereof, be interpreted sufficiently broadly to include alternative methods of automated data acquisition such as photography and scanning. Accordingly, various implementations include capturing or acquiring at least one image of a surface of the mail piece and storing the at least one image in computer memory. Depending on whether it is desired to preserve the capacity to re-associate the at least one image with the physical mail piece to facilitate future handling, alternative aspects include the steps of marking the physical mail piece with a unique identification mark representing its identity and storing a computer memory record of the identification mark in association with the at least one stored image acquired from a surface of the mail piece. Ensuring that the at least one image extracted from physical mail piece includes at least that portion of the postage-fee accounting indicia representative of the postal-fee payment code embedded therein facilitates charge assessment to the appropriate postal customer.

The at least one captured image acquired from the mail piece is resolved by interpretation algorithms to produce a resolved data set associated with the physical mail piece and is indicative of at least the postage-fee payment code embedded in the postage-fee accounting indicia. The resolved data set may also include at least a portion of any additional information embedded in the postage-fee accounting indicia (e.g., delivery address, etc.) and/or resolved data indicative of information exhibited elsewhere on the mail piece such as, by way of non-limiting example, information for the human-readable delivery address block. It is envisioned that a typical implementation will execute image acquisition for accounting and automated address interpretation contemporaneously in order to minimize the required number of information extractions necessary to sort, route and deliver the mail piece and assess a charge to the appropriate postal customer for the service.

The postal-customer account database is consulted and the resolved data set associated with the physical mail piece is compared to postal-customer data in the database in an effort to identify a unique postage-request data set including data indicative of a postage-fee payment code that corresponds with resolved image data indicative of at least the postal-fee payment code exhibited on the physical mail piece. If unique data correspondence is established to the satisfaction of a predetermined confidence threshold, and the postage-fee code associated with the identified postage-request data set is active, a charge is automatically assessed to lo the postal-customer associated with the uniquely identified postal customer account. In alternative implementations, the process continues relative to subsequent mail pieces as described until, for example, any of the following conditions is met: (i) the balance of available funds associated with the postal-customer request is insufficient to cover the sortation and delivery of a mail piece, (ii) automated sortation machinery, and associated algorithms, determine that any established postage-expiration date has elapsed, and (iii) a pre-established fraud-detection condition is satisfied. When a determination is rendered indicating that the order as specified in the postal-customer request has been filled (i.e., the authorized number of mail pieces associated with the request has been detected in the mail stream), various implementations designate the postage-fee payment code as inactive and, furthermore, segregate as undeliverable, at least in accordance with the ordinary order of operations, any mail piece exhibiting that code that is subsequently detected in the mail stream. The postage-fee payment code may, in alternative implementations, be designated as inactive when other conditions specific to the particular implementation are satisfied. For instance, the postage-fee payment code may be designated as inactive when a determination is rendered that a postage expiration date associated with the postage-request data set has elapsed.

Various implementations of the process include measures to prevent the assessment of multiple postal charges for the handling of a particular mail piece. More specifically, because multiple mail pieces associated with a particular postal-customer request-exhibit the same postage-fee payment code, implementations of the process must have the capacity to distinguish one associated mail piece from another or otherwise have in place measures against “double-counting” a single mail piece for purposes of postal-charge assessment. Alternative illustrative measures include (i) initiating charge-assessment processes subsequent to the first image extraction and marking the physical mail piece with a machine detectable postage-paid indicia (e.g., a cancellation mark) so that automated processing machinery detecting the mail piece downstream in the sortation process does not initiate another cycle of charge-assessment processes in connection with that mail piece; (ii) relying on the system of unique identification of mail pieces that is already in place at most, if not all, postal systems and in accordance with which each mail piece of a selected set of mail pieces passing through the system as applied to it a unique identification mark for automated sortation purposes as described in the detailed description. For reasons that will likely be readily understood by those of ordinary skill in the art but which are, in any event, will be more completely appreciated in connection with the detailed description, the use of a cancellation mark for accounting purposes may, in various implementations, obviate the need for repeated “call-ups” from memory of resolved data linked to a physical mail piece through the use of the unique identification mark applied by the postal service.

In addition to other attributes associated with various implementations, it will be appreciated that the configuration of automated mail sortation apparatus to automatically assess postal charges to appropriate response services postal customers substantially reduces the manual handling of such mail pieces, and the cost and potential for errors associated therewith.

Representative implementations are more completely described and depicted in the following detailed description and the accompanying drawings.

### BRIEF DESCRIPTION OF THE DRAWINGS

FIG. 1 is a schematic representation of a system facilitating the on-demand printing of postage-fee payment indicia by a requesting postal customer, the application of those indicia to response services mail pieces, the movement of the response service mail pieces to intended recipients, and the return of such response service mail pieces to the requesting postal customer, and the postal charge assessment associated therewith;

FIG. 2 depicts an illustrative business reply mail piece exhibiting, in addition to human-readable information, an encoded postage-fee accounting indicia;

FIG. 3 is a block diagram of an illustrative mail processing system and architecture for the movement of mail pieces and postal charge assessment associated therewith; and

FIG. 4 is a flow chart depicting an illustrative decision logic implementing an illustrative charge-assessment protocol.

### DETAILED DESCRIPTION

The following description of a postage charge-assessment processes and architecture, and various implementations thereof, is demonstrative in nature and is not intended to limit the invention or its application of uses.

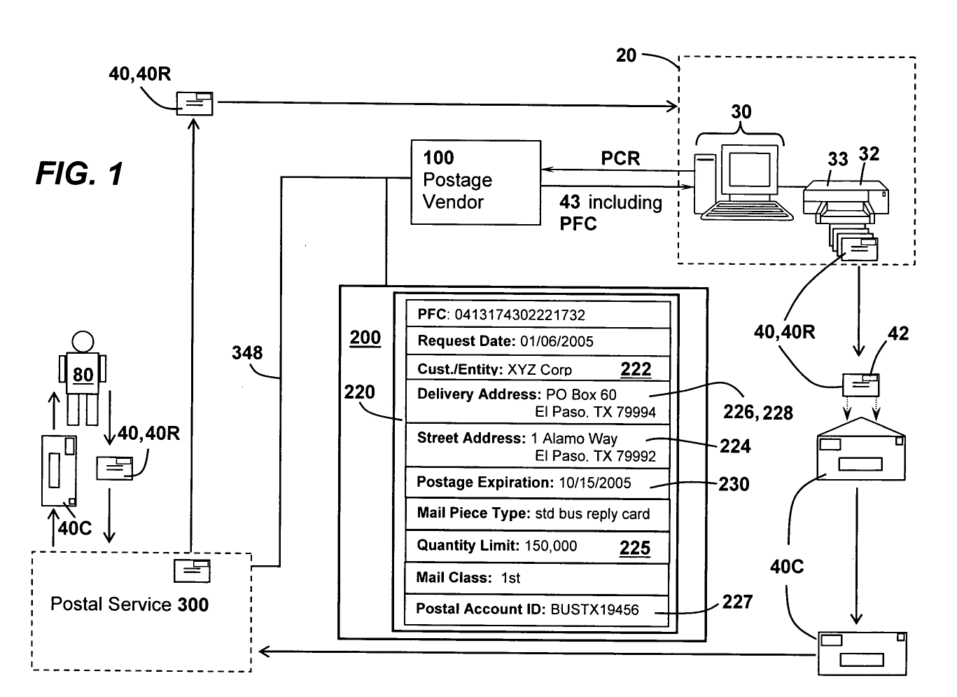

Referring to FIG. 1, a typical implementation involves participation by a response services (e.g., business reply) postal customer 20, a postage vendor 100, a postal service (or system) 300 that receives, handles and delivers mail pieces to addressees, and a response-services mail piece recipient 80 who introduces a response services mail piece 40R into the postal system in response, for example, to a solicitation or offer from the response services postal customer 20.

An illustrative process is initiated with the communication of a postal-customer request PCR by a postal customer 20 to a postage vendor 100. The postal-customer request PCR is communicated from a requesting station 30 which, in a typical implementation, is a general use computer or computer terminal, but which may also be a dedicated computer or other dedicated postage-requesting apparatus (e.g., a meter). Moreover, the requesting station 30 may, in alternative implementations, be situated at the place of business of the postal customer 20 on whose behalf the request is initiated, at the place of business of an entity contracting with the postal customer 20 for the production of mail pieces or at a postage kiosk (not specifically illustrated), by way of non-limiting example. In the schematic depiction of FIG. 1, the requesting station 30 is shown as directly communicatively linked, as indicated by a solid line, to the postage vendor 100, but it will be appreciated that communications links among the postal customer 20, the postage vendor 100 and the postal system 300 in a typical implementation will be through a communications network such as the Internet.

In response to the postal-customer request PCR to the postage vendor 100, a “group” or “collective” postal-fee payment code PFC is associated with data indicative of the identity of the requesting postal customer 20 and other, optional information, and a computer memory record in the form of a postage-request data set 220 including data indicative of the postal-fee payment code PFC and of the postal customer's identity is stored in a postal-customer account database 200 that stores data uniquely relating each requesting postal customer 20 with data indicative of a set of postal-customer requests PCR registered in association with that postal customer 20. It is of no particular importance whether a postal-fee payment code PFC is freshly generated in response to the request or whether a bank of pre-generated postal-fee payment codes PFC is created with postal-fee payment codes PFC therein being issued as postal-customer requests PCR are received. An illustrative postage-request data set 220 associated with a postal-customer request PCR includes, by way of non-limiting example, an entity name 222, an entity street address 224, a delivery address 226, and a pre-established postal account identifier 227 (e.g., account number). As aforementioned in the summary, additional alternative information for charge-assessment purposes includes (i) financial-institution routing and account numbers and (ii) a credit card number (not shown). The postal-customer account database 200 is, in alternative embodiments, maintained (i) at the postage vendor 100, (ii) at the postal service 300 and (iii) at a third location external to the postage vendor 100 and the postal service 300. Regardless of the physical location of the postal-customer account database 200, the vendor 100 and the postal service 300 will, at various times in the execution of the handling and accounting processes associated with a particular physical mail piece 40, require communicative access thereto.

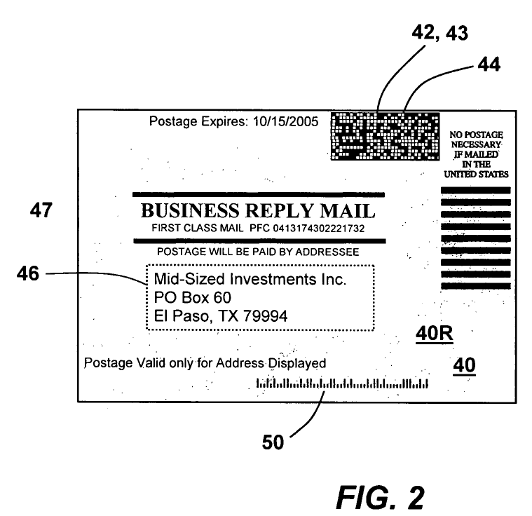

The collective postal-fee payment code PFC is communicated to the requesting postal customer 20 and is, in various aspects, authorized to be associated with, and exhibited on, a predetermined quantity of physical mail pieces 40, such as reply mail pieces 40R, to be introduced into the postal system 300. In a typical implementation, the postal-fee payment code PFC is embedded in graphic 42 which, in the example shown on the illustrative business reply mail piece 40R of FIG. 2, is a two-dimensional data matrix 44 of a general type known to those of ordinary skill in the relevant arts. The graphic 42 serves as postage-fee accounting indicia 43 and may also include coded portions corresponding to and indicative of other, optional information as indicated above, for example, in connection with the illustrative postage-request data set 220 associated with the postal-customer request PCR under consideration. It will be appreciated that, in some versions, the graphic 42 will have encoded information corresponding to information exhibited in human-readable format on the mail piece 40. Although, in various implementations, automated mail sortation apparatus within the postal service system 300 rely primarily on information encoded in the graphic 42 for sortation and accounting purposes, the display of some of the encoded information in human-readable format serves the functions of (i) permitting the requesting postal customer 20 to verify by visual inspection the correctness of certain information exhibited on the mail piece 40 and (ii) facilitating manual handling of the mail piece 40 by personnel within the postal service 300 when manual handling is necessitated by, for example, the incomprehensibility of the graphic 42 to interpretation algorithms due, for example, to damage, defacement or obstruction.

As discussed previously in the summary, a predetermined authorized quantity of mail pieces 40 is another example of additional information that may be explicitly stated as part of the postal-customer request PCR or implicitly authorized by a stated dollar amount up to which postage fees may be assessed to the postal customer 20 in connection with that request PCR. The illustrative postage-request data set 220 shown in FIG. 1 indicates, at data field 225, a fixed mail piece quantity limit of 150,000 mail pieces 40. Also discussed in the summary as a measure of security against fraudulent use of a postal-fee payment code PFC, and indicated in the postage-request data set 220 of FIG. 1, is the association with the postal-fee payment code PFC of a valid-delivery address set 228 which set, in this case, includes only the single destination (i.e., delivery) address 226 of P.O. Box 60, El Paso, Tex. 79994. Restricting the number of destination addresses to which mail pieces 40 exhibiting the postal-fee payment code PFC can be delivered prevents losses due to fraudulent duplication of the postage-fee accounting indicia 43 for the mailing of mail pieces 40 to unauthorized addresses. Optionally, mail pieces 40 authorized to exhibit the postage-fee accounting indicia 43 include a human readable notice indicating that authorized delivery is restricted to the address as it is optionally displayed in human-readable format on the mail piece 40. An illustrative, non-limiting example of such a notice appears on the business reply mail piece 40R of FIG. 2 wherein text included on the mail piece 40R states “Postage Valid only for Address Displayed.” Still further associated with the postage-request data set 220 in FIG. 1 is an indication of a postage-expiration date 230. Some advantages of specifying a postage-expiration date 230 were discussed in the summary and are not repeated in this detailed description. In a typical implementation in which a postage-expiration date 230 is associated with the postage-request data set 220, data indicative of the postage-expiration date 230 is embedded in the postage-fee payment indicia 43 exhibited on an authorized mail piece 40. The illustrative mail piece 40R of FIG. 2 also includes a human-readable indication of a postage expiration date 230 of “Oct. 15, 2005.”

Referring again to FIG. 1, the postage-fee accounting indicia 43 associated with a postal-customer request PCR in a postage-request data set 220, and including at least a postage-fee payment code PFC, is communicated (i.e., rendered accessible) to the requesting postal customer 20. The requesting postal customer 20 causes to have iteratively applied to a plurality of response services mail pieces 40R tangible renditions of the postage-fee accounting indicia 43. For example, a rendition of the indicia 43 may be directly applied by indicia-applying apparatus 32 (e.g., computer printer 33) to cards (shown) each of which will serve as a business reply mail piece 40R. As previously indicated, identical postage-fee accounting indicia 43 are applied to all the response services mail pieces 40R associated with a particular postal-customer request PCR.

In order to convey each business reply mail piece 40R to an intended response-services mail piece recipient 80, the business reply mail piece 40R is, in this example, packaged in a carrier mail piece 40C addressed to the intended response-services mail piece recipient 80, as shown in FIG. 1. The carrier mail piece 40C is then introduced into the postal system 300 and sorted, routed and delivered to the intended recipient 80 in the ordinary course who, in turn, will discard, retain or introduce the enclosed business reply mail piece 40R into the postal system 300 for delivery to the requesting postal customer 20. No postage charge is assessed to the requesting postal customer 20 for any business reply mail piece 40R retained or discarded by a response-services mail piece recipient 80. The illustrative recipient 80 of FIG. 1, however, is schematically shown introducing into the postal system 300 a business reply mail piece 40R associated with the postage-request data set 220 and the requesting postal customer 20, and shown in FIG. 2.

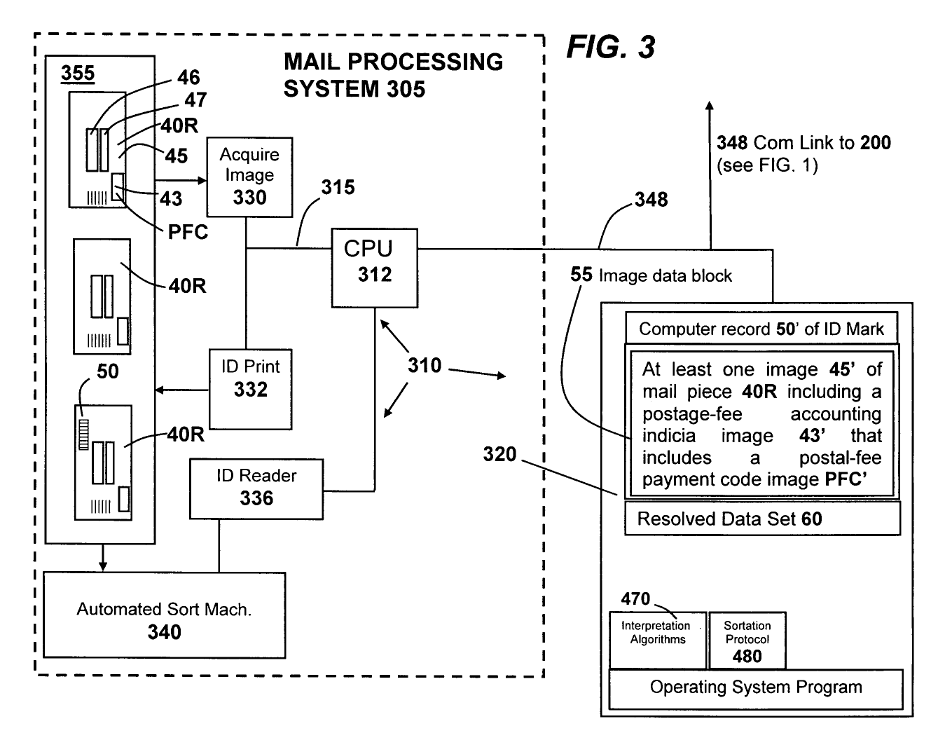

FIG. 3 is a function-block diagram of the illustrative architecture at, and accessible to, an illustrative mail processing system 305 associated with the postal system 300 into which the business reply mail piece 40R is introduced. It is important to understand that FIG. 3 is schematic in nature and that operations shown therein, and described in association therewith, may occur at different facilities associated with the postal system 300; the schematic being representative of illustrative postal-system functions as a whole relative to the handling of business reply mail piece 40R. The mail processing system 305 includes access to a data processing system 310, which may be at least partially located outside of the mail processing system 305. The data processing system 310 includes a central processing unit (CPU) 312 that is communicatively linked to a memory 320, image acquisition apparatus 330, a printer 332, and an identification-mark reader 336. The system architecture further includes automated sorting machinery 340 communicatively linked to the CPU 312. The CPU 312 is furthermore communicatively linked via a communications link 348 with the postal-customer account database 200 (see FIG. 1).

Within the illustrative mail processing system 305 of FIG. 3, the business reply mail piece 40R exhibiting the postage-fee accounting indicia 43 that was received into the postal system 300 from the depositing response-services mail piece recipient 80 is deposited on a conveyor 355 by which it is conveyed passed the image acquisition apparatus 330. In a manner consistent with automated processes already in place for address interpretation purposes, and well-known to those of ordinary skill in the relevant arts, the image acquisition apparatus 330 captures at least one image 45′ of the front face 45 of the physical mail piece 40R and stores each captured image 45′ as a two-dimensional bit plane of pixels, for example, in memory 320. A unique identification mark 50 is associated with the captured image(s) 45′ and a computer memory record 50′ of the unique identification mark 50 is stored in conjunction therewith in an image data block 55 corresponding to the physical mail piece 40R. Typically, the identification mark 50 comprises a bar code, for example. A printer 332 prints the unique identification mark 50 on the physical mail piece 40R. The unique identification mark 50 allows the corresponding captured image(s) 45′ to be accessed and, when necessary, re-associated with the corresponding physical mail piece 40R. The captured image(s) 45′ typically include image data representative of the destination address field 46 and any human-readable business reply license plate 47 that may be exhibited, for example, consistent with the manner in which mail processing as a whole is conducted presently. However, image extraction of the machine-readable postage-fee accounting indicia 43, including the postage-fee payment code PFC, is most important to implementations of the current invention. Accordingly, as shown in FIG. 3, the at least one captured image 45′ of mail piece 40R shown in the image data block 55 specifies the inclusion of a postage-fee accounting indicia image 43′ including a postal-fee payment code image PFC′. However, as previously discussed, and as will be appreciated by those of ordinary skill in the mail-processing art, the more information about the mail piece 40R that is accurately encoded in the postage-fee accounting indicia 43, the better the chances that the mail piece 40R will be sorted by automated sorting machinery 340 and delivered without error. For instance, if the delivery address information associated at data field 226 in the postage-request data set 220 associated with mail piece 40R is encoded into the postage-fee payment indicia 43, then the delivery address is already in a machine-friendly language and reliance need not be placed exclusively on the accurate algorithmic interpretation of the human-readable information exhibited in the destination address field 46. In other words, in various implementations, mail-piece sortation and charge-assessment accuracy is improved when renditions of the postage-fee accounting indicia 43 including, for example, information indicative of the authorized delivery address 226 are exhibited on mail pieces 40R in a machine-readable format extracted images of which are more readily resolvable by interpretation algorithms than extracted images of information exhibited in a human-readable format.

While the business reply mail piece 40R to which a set of stored images 45′ corresponds is still within the mail processing system 305, interpretation algorithms 470 resolve (or interpret) at least enough destination-address image data to render routing decisions and to generate sortation signals for the sorting machinery 340 to appropriately sort and route the mail piece 40R at each stage in the journey of the mail piece 40R through the system 305. As image data is resolved, a resolved data set 60 is formed and associated with the computer memory record 50′ of the unique identification mark 50. As required in connection with each subsequent stage in the sortation process, the unique identification mark 50 applied by the printer 332 to the physical mail piece 40R is read (e.g., scanned) by an identification mark reader 336 in order to facilitate consultation with the associated resolved data set 60 stored in memory 320 for the purposes of rendering accessible to the automated sorting machinery 340 the next required set of sortation signals which, again, is part of an overall process currently in use and known to those of skill in the art. Accordingly, further details of automated sortation processes based on the algorithmic interpretation (i.e., resolution) of captured images 45′ are provided only insofar as they facilitate an understanding of the automated charge-assessment aspects of a typical implementation. Worth noting, however, is that various implementations execute image acquisition for purposes of accounting and automated address interpretation contemporaneously in order to minimize the required number of information extractions necessary to sort, route and deliver the mail piece 40 and assess a charge to the appropriate postal customer 20 for the service.

Referring to FIGS. 3 and 1, the postal-customer account database 200 (shown in FIG. 1) is consulted and the resolved data set 60 associated with the physical mail piece 40R is compared to postal-customer data in the account database 200 in order to determine whether a unique postage-request data set 220 including data indicative of a postage-fee payment code PFC corresponds with resolved image data in the resolved data set 60 associated with the postal-fee payment code PFC encoded on the physical mail piece 40R. To the extent that unique data correspondence is established to the satisfaction of a predetermined confidence threshold and, in various implementations, other charge-assessment criteria are met in accordance with an automated charge-assessment protocol 480, a charge is automatically assessed to the requesting postal customer 20 associated with the uniquely identified postage-request data set 220. In alternative implementations, the process continues relative to mail pieces 40R as described until, for example, any of the following criterion is met: (i) the balance of available funds associated with the postal-customer request is insufficient to cover the sortation and delivery of a mail piece 40R, (ii) automated sorting machinery 340, and associated algorithms implementing the charge-assessment protocol 480, determine that any established postage-expiration date has elapsed, and (iii) a pre-established condition for potential fraud is met. When a determination is rendered indicating that the order as specified in the postal-customer request PCR has been filled (i.e., the number of mail pieces 40R authorized to be associated with the request PCR has been detected in the mail stream), various implementations designate the postage-fee payment code PFC as inactive such that any mail piece 40R exhibiting that code PFC that is subsequently detected in the mail stream is segregated as undeliverable (e.g., “dumped” out of the deliverable mail stream) or is otherwise handled. A typical implementation registers the number of detected mail pieces 40R associated with each postage-fee fee payment code PFC in order to facilitate accurate charge-assessment and, in cases in which a mail-piece or funds-available limit is associated with postage-fee payment code PFC, to designate the postage-fee payment code PFC as “inactive” at the appropriate juncture. As previously described, however, charge-assessment, in alternative implementations, continues in open-ended fashion with no limit on mail pieces of funds available.

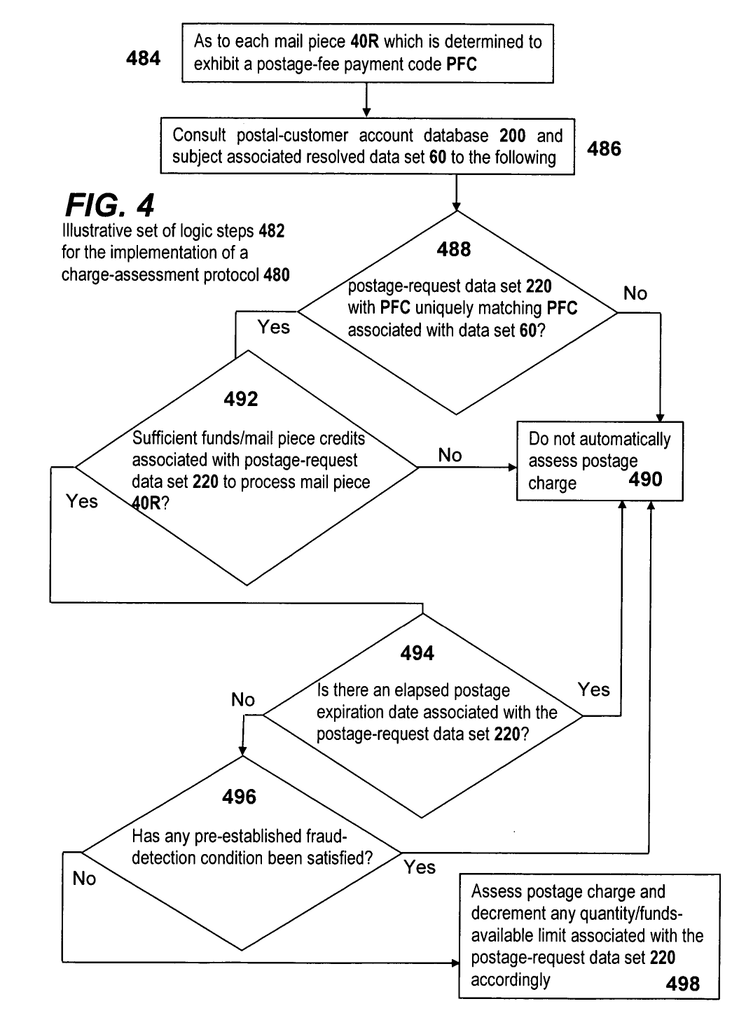

FIG. 4 is a flow chart representation of an illustrative set of steps that may be wholly or partially implemented in association with an automated charge-assessment protocol 480. Accordingly, it is to be understood that the automated-charge-assessment logic 482 depicted in FIG. 4 is purely illustrative in nature and should not be interpreted as a limitation on automated charge-assessment processes as expressed in the claims, including limitations with respect to the order of operations and to the inclusion or exclusion of any of the steps depicted. As shown at block 484, the illustrative logic 482 presupposes the exhibition and detection of a postage-fee payment code PFC on the physical mail piece 40R for which the logic 482 is executed. At step 486, the postal-customer account database 200 is consulted and the resolved data set 60 associated with the physical mail piece 40R is subjected to a set of queries in order to determine whether a postage charge will be automatically assessed. At step 488, the automated-charge-assessment logic 482 calls for a decision as to whether a postage-request data set 220 within the postal-customer account database 200 has associated therewith a postage-fee payment code PFC that uniquely matches (i.e., from among other postage-request data sets in the database 200) the postage-fee payment code PFC associated with the resolved data set 60 pursuant to the algorithmic interpretation of the at least one captured image 45′ of the mail piece 40R. If no single postage-request data set 220 is identifiable, the logic 482 associated with the automated charge-assessment protocol 480 indicates at 490 that a postage charge not be automatically assessed. In accordance with decision step 492, a determination is rendered as to whether sufficient funds or “mail piece credits” are associated with a uniquely matched postage-request data set 220 in order to further process the mail piece 40R. “Mail piece credits” are essentially an indication as to the authorized quantity of mail pieces 40R that a requesting postal customer 20 has caused to be associated with the postal-customer request PCR less any credits that may have already been expended. Illustrative manners of expressing the quantity of mail pieces 40R a requesting postal customer 20 is entitled to have handled by the postal system 300 in association with a particular postal-customer request PCR were previously discussed and will not be further discussed here. According to the illustrative logic 482 under consideration, if the funds or mail-piece quantity limit (i.e., credits) remaining in association with the postage-request data set 220 is not sufficient to further handle the mail piece 40R for which the logic 482 is presently being executed, the protocol 480 indicates at 490 that no postage charge is automatically assessed. In such a case, the mail piece 40R would, for example, be segregated from the normal flow of mail for manual or other alternative handling. Another alternative is to charge a premium for the handling of the mail piece 40R and for whatever extra steps may be required to assess charges to the requesting postal customer 20 (e.g., billing by mail). If, pursuant to decision step 492, a determination is rendered indicating sufficient funds or mail piece credits associated with the postage-request data set 220, the illustrative logic 482 proceeds to query 494 for a determination as to whether there is associated with the postage-request data set 220 an elapsed postage expiration date 230. If there is an associated postage expiration date 230 that has elapsed, then the automated charge-assessment process, at least as implemented by illustrative protocol 480, ceases as indicated at 490. If either (i) no postage expiration date 230 was ever associated with the postage-request data set 220 or (ii) a postage expiration date 230 was associated with the postage-request data set 220, but it has not elapsed at the time of the inquiry, then the logic 482 proceeds to decision step 496 for a determination as to whether any pre-established fraud-detection conditions is satisfied. Representative fraud-detection conditions were previously discussed and will not be fully discussed again except to state that, in a typical implementation, conditions are chosen that indicate inconsistency in information indicated in the identified postage-request data set 220 and the resolved data set 60 associated with a particular mail piece 40R under consideration. For instance, if, in a particular implementation, the postage-fee accounting indicia 43 includes an encoded postage-fee payment code PFC and, for example, no delivery address information and, furthermore, interpretation algorithms 470 resolve from an image 45′ of the destination address field 46 exhibited on the physical mail piece 40R a delivery address that is different from the address indicated in the delivery address data field 226 associated with the postage-request data set 220, then potential fraud is indicated. When such a pre-established fraud-detection condition is satisfied, the mail piece 40R is segregated from the regular mail flow and no charge is automatically assessed to the requesting postal customer 20 as indicated at 490. If, in accordance with the illustrative logic 484, no fraud-detection condition is satisfied, then a postage charge is automatically assessed by, for example, decrementing any remaining funds limit indicated in association with the postage-request data set 220 by an amount reflective of the postage required for handling the mail piece 40R under consideration or decrementing any mail-piece quantity limit, such as that indicated at field in association with the postage-request data set 220 in FIG. 1, by “1.”

The foregoing is considered to be illustrative of the principles of the invention. Furthermore, since modifications and changes will occur to those skilled in the art without departing from the scope and spirit of the invention, it is to be understood that the foregoing does not limit the invention as expressed in the appended claims to the exact construction, implementations and versions shown and described.

What is claimed is:

1. A method of implementing a postal-revenue collection system according to which (i) a postal customer can apply postage-fee accounting indicia to a mail piece on demand and (ii) the postal customer is charged postage only for mail pieces exhibiting the postage-fee accounting indicia that are actually detected in the postal system, the method comprising the steps of:
associating, in response to a postal-customer request electronically communicated from a requesting postal customer to a postage vendor, a postal-fee payment code with data indicative of the identity of the requesting postal customer, the postal-fee payment code being a collective code to be associated with a plurality of mail pieces authorized to be introduced into the postal system;
storing, in a postal-customer account database in which are stored data uniquely relating each requesting postal customer with data indicative of a set of postal-customer requests registered in association with that postal customer, a postage-request data set including data indicative of at least each of the identity of the requesting postal customer and the associated collective postage-fee payment code;
communicating from the postage vendor to the requesting postal customer a postage-fee accounting indicia to be applied to each mail piece of the plurality of mail pieces with which the postal-fee payment code is authorized to be associated, the postage-fee accounting indicia being indicative of at least the postal-fee payment code;
receiving into the postal system a mail piece including a surface exhibiting the postage-fee accounting indicia;
extracting an image of at least that portion of the mail-piece surface exhibiting the postage-fee accounting indicia;
resolving the extracted image and storing in computer memory a resolved data set associated with the mail piece and including resolved data indicative of at least the postage-fee payment code exhibited on the corresponding mail piece;
consulting the postal-customer account database and comparing the resolved data set associated with the mail piece to postal-customer account data in the postal-customer account database in order to determine whether a unique postage-request data set including data indicative of a postage-fee payment code corresponds with data in the resolved data set associated with the postage-fee payment code exhibited on the mail piece; and,
to the extent there is identified to the satisfaction of a predetermined confidence threshold a postage-request data set associated with an active postage-fee payment code and including data that uniquely corresponds with data in the resolved data set, assessing a postage charge to the requesting postal customer associated with the uniquely identified postage-request data set.

2. The method of claim 1 further comprising the step of enabling the requesting postal customer to associate with the postage-fee payment code associated with the postal-customer request at least one of:
(i) a limit on the authorized quantity of mail pieces exhibiting the postage-fee payment code that can be detected in the postal system; and
(ii) a limit on the total funds available for the payment of postage relative to mail pieces exhibiting the postage-fee payment code.

3. The method of claim 2 further comprising the step of designating as inactive a postage-fee payment code with which there is associated a limit on one of (i) the authorized quantity of mail pieces exhibiting the postage-fee payment code that can be detected in the postal system and (ii) a limit on the total funds available for the payment of postage relative to mail pieces exhibiting the postage-fee payment code when there is detected in the postal system a mail piece exhibiting the postage-fee payment code in connection with which mail piece the assessment of a postage charge would cause a limit associated with the corresponding postal-customer request to be exceeded.

4. The method of claim 1 further comprising:
enabling the requesting postal customer to associate with the postage-fee payment code associated with the postage-request data set a postage expiration date; and
designating as inactive a postage-fee payment code with which there is associated a postage expiration date that has elapsed.

5. The method of claim 1 further comprising:
enabling the requesting postal customer to associate with the postage-request data set at least one authorized delivery address to which delivery of mail pieces exhibiting the postal-fee accounting indicia associated with the postage-request data set is restricted.

6. The method of claim 5 further comprising:
regarding as potentially fraudulent the exhibition on a mail piece of (i) a postage-fee payment indicia with which there is associated in a postage-request data set at least one authorized delivery address and (ii) a delivery address that does not correspond to any of the at least one authorized delivery addresses.

7. The method of claim 1 wherein, in addition to being indicative of the postage-fee payment code, the postage-fee accounting indicia associated with the postage-request data set and communicated to the requesting postal customer includes data indicative of at least one of (i) an authorized delivery address and (ii) a postage expiration date such that renditions of the postage-fee accounting indicia applied to mail pieces exhibit information indicative of at least one of, respectively, (i) an authorized delivery address and (ii) a postage expiration date.

8. The method of claim 7 wherein (i) the postage-fee accounting indicia associated with a postage-request data set and communicated to a requesting postal customer includes data indicative of an authorized delivery address and (ii) renditions of the postage-fee accounting indicia including information indicative of the authorized delivery address that are applied to mail pieces are exhibited in a machine-readable format extracted images of which are more readily resolvable by interpretation algorithms than extracted images of a human-readable format.

9. The method of claim 8 wherein renditions of the postage-fee accounting indicia are exhibited on mail pieces in one of (i) a one-dimensional bar code and (ii) a two-dimensional data matrix.

10. The method of claim 1 wherein the mail pieces authorized to be introduced into the postal system are response service mail pieces.

11. A method of implementing a postal-revenue collection system according to which a requesting postal customer is charged postage only for mail pieces associated with that postal customer that are detected in the postal system, the method comprising the steps of:
associating, in response to a postal-customer request electronically communicated from a requesting postal customer to a postage vendor, a postal-fee payment code with data indicative of the identity of the requesting postal customer, the postal-fee payment code being a collective code to be associated with a plurality of mail pieces authorized to be introduced into the postal system;
storing, in a postal-customer account database in which are stored data uniquely relating each requesting postal customer with data indicative of a set of postal-customer requests registered in association with that postal customer, a postage-request data set including data indicative of at least each of the identity of the requesting postal customer and the associated collective postage-fee payment code;
communicating from the postage vendor to the requesting postal customer a postage-fee accounting indicia to be applied to each mail piece of the plurality of mail pieces with which the postal-fee payment code is authorized to be associated, the postage-fee accounting indicia being indicative of at least the postal-fee payment code;
receiving into the postal system a mail piece including a surface exhibiting the postage-fee accounting indicia;
extracting an image of at least that portion of the mail-piece surface exhibiting the postage-fee accounting indicia;
resolving the extracted image and storing in computer memory a resolved data set associated with the mail piece and including resolved data indicative of at least the postage-fee payment code exhibited on the corresponding mail piece;
consulting the postal-customer account database and comparing the resolved data set associated with the mail piece to postal-customer account data in the postal-customer account database in order to determine whether a unique postage-request data set including data indicative of a postage-fee payment code corresponds with data in the resolved data set associated with the postage-fee payment code exhibited on the mail piece;
enabling the requesting postal customer to associate with the postage-fee payment code associated with the postage-request data set a single authorized delivery address to which delivery of mail pieces exhibiting the postage-fee accounting indicia is restricted; and,
to the extent there is identified to the satisfaction of a predetermined confidence threshold a postage-request data set associated with an active postage-fee payment code and including data that uniquely corresponds with data in the resolved data set, assessing a postage charge to the requesting postal customer associated with the uniquely identified postage-request data set.

12. The method of claim 11 further comprising:
regarding as potentially fraudulent the exhibition on a mail piece of (i) a postage-fee payment indicia with which there is associated a single authorized delivery address and (ii) a delivery address that does not correspond to the single authorized delivery address.

13. The method of claim 11 wherein (i) the postage-fee payment code has associated therewith a single authorized delivery address to which delivery of mail pieces exhibiting the postage-fee accounting indicia is restricted, (ii) the postage-fee accounting indicia associated with the postage-request data set includes, in addition to data indicative of the postage fee payment code, data indicative of the single authorized delivery address, and (iii) renditions of the postage-fee accounting indicia including information indicative of the authorized delivery address that are applied to mail pieces are exhibited in a machine-readable format extracted images of which are more readily resolvable by interpretation algorithms than extracted images of a human-readable format.

14. The method of claim 13 further comprising:
enabling the requesting postal customer to associate with the postage-fee payment code associated with the postage-request data set a postage expiration date; and
designating as inactive a postage-fee payment code with which there is associated a postage expiration date that has elapsed.

15. The method of claim 11 further comprising:
enabling the requesting postal customer to associate with the postage-fee payment code associated with the postage-request data set a postage expiration date; and
designating as inactive a postage-fee payment code with which there is associated a postage expiration date that has elapsed.

16. The method of claim 15 wherein (i) the postage-fee payment code has associated therewith a postage expiration date, (ii) the postage-fee accounting indicia associated with the postage-request data set includes, in addition to data indicative of the postage fee payment code, data indicative of the postage expiration date, and (iii) renditions of the postage-fee accounting indicia including information indicative of the postage expiration date that are applied to mail pieces are exhibited in a machine-readable format extracted images of which are more readily resolvable by interpretation algorithms than extracted images of a human-readable format.

17. A method of implementing a postal-revenue collection system according to which a requesting postal customer is charged postage only for mail pieces associated with that postal customer that are detected in the postal system, the method comprising the steps of:
associating, in response to a postal-customer request electronically communicated from a requesting postal customer to a postage vendor, a postal-fee payment code with data indicative of the identity of the requesting postal customer, the postal-fee payment code being a collective code to be associated with a plurality of mail pieces authorized to be introduced into the postal system;
storing, in a postal-customer account database in which are stored data uniquely relating each requesting postal customer with data indicative of a set of postal-customer requests registered in association with that postal customer, a postage-request data set including data indicative of at least each of the identity of the requesting postal customer and the associated collective postage-fee payment code;
communicating from the postage vendor to the requesting postal customer a postage-fee accounting indicia to be applied to each mail piece of the plurality of mail pieces with which the postal-fee payment code is authorized to be associated, the postage-fee accounting indicia being indicative of at least the postal-fee payment code;
receiving into the postal system a mail piece including a surface exhibiting the postage-fee accounting indicia;
extracting an image of at least that portion of the mail-piece surface exhibiting the postage-fee accounting indicia;
resolving the extracted image and storing in computer memory a resolved data set associated with the mail piece and including resolved data indicative of at least the postage-fee payment code exhibited on the corresponding mail piece;
consulting the postal-customer account database and comparing the resolved data set associated with the mail piece to postal-customer account data in the postal-customer account database in order to determine whether a unique postage-request data set including data indicative of a postage-fee payment code corresponds with data in the resolved data set associated with the postage-fee payment code exhibited on the mail piece;
enabling the requesting postal customer to associate with the postage-fee payment code a postage expiration date;
designating as inactive a postage-fee payment code with which there is associated a postage expiration date that has elapsed; and,
to the extent there is identified to the satisfaction of a predetermined confidence threshold a postage-request data set associated with an active postage-fee payment code and including data that uniquely corresponds with data in the resolved data set, assessing a postage charge to the requesting postal customer associated with the uniquely identified postage-request data set.

18. The method of claim 17 wherein (i) the postage-fee payment code has associated therewith a postage expiration date, (ii) the postage-fee accounting indicia associated with the postage-request data set includes, in addition to data indicative of the postage fee payment code, data indicative of the postage expiration date, and (iii) renditions of the postage-fee accounting indicia including information indicative of the postage expiration date that are applied to mail pieces are exhibited in a machine-readable format extracted images of which are more readily resolvable by interpretation algorithms than extracted images of a human-readable format.

19. The method of claim 17 further comprising:
enabling the requesting postal customer to associate with the postage-fee payment code associated with the postage-request data set a single authorized delivery address to which delivery of mail pieces exhibiting the postage-fee accounting indicia is restricted.

20. The method of claim 19 further comprising:
regarding as potentially fraudulent the exhibition on a mail piece of (i) a postage-fee payment indicia with which there is associated in a postage-request data set at least an authorized delivery address and (ii) a delivery address that does not correspond to any of the at least one authorized delivery addresses.
